(19) United States
(12) Patent Application Publication
(10) Pub. No.: US 2005/0061424 A1
(43) Pub. Date: Mar. 24, 2005

(54) Workpiece forming

(76) Inventors: Michael Colin Ackerman, Bristol (GB); Terry Flower, Goucestershire (GB); Allan Keevil, Somerset (GB); Jerome Way, Wickwar (GB); Alan Jocelyn, Bristol (GB); Douglas Nash, Bristol (GB); Aravinda Kar, Oviedo, FL (US)

Correspondence Address: OLIFF & BERRIDGE, PLC, P.O. BOX 19928, ALEXANDRIA, VA, 22320, US

(21) Appl. No.: 10/485,182

(22) PCT Filed: Aug. 7, 2002
(86) PCT No.: PCT/GB02/03634

(30) Foreign Application Priority Data
Aug. 8, 2001 (GB) 0119371.3

(51) Int. Cl. B32B 1/00; B29C 47/00

(52) U.S. Cl. 156/245; 264/242

(57) ABSTRACT

A method of forming a workpiece (18) comprises: holding the workpiece adjacent a mould (20); using a laser (30) to heat at least a part of the workpiece to a temperature sufficient to induce superplasticity; and applying a fluid pressure to the workpiece, so that it takes the shape of the mould. This has the advantage that the superplastic properties of the material can be used to form the workpiece precisely to the required shape, without needing to heat all of the processing chamber to the superplastic temperature. Before using the laser to heat the workpiece to its superplastic temperature, the laser can be used to heat the whole of the workpiece to a substantially uniform temperature to anneal it. Similarly, after using the laser to superplastically form the workpiece, the laser is used to heat the whole of the workpiece to a substantially uniform temperature to remove any residual stresses. This has the advantage that the whole of the forming can be carried out as a single process, in a single processing apparatus.

This invention relates to a method of shaping a workpiece, and in particular to a method of superplastic forming of a suitable material.

It is known that certain alloys become superplastic at specific elevated temperatures. At these temperatures, the superplasticity usefully allows the alloy to be formed into a desired shape.

One method of forming a workpiece is to place a sheet of the alloy material over a die, or mould, and then to heat the workpiece to a temperature at which the alloy becomes superplastic, and then to apply pressure to the workpiece, for example by applying a high fluid pressure to the upper surface of the workpiece while maintaining a lower pressure in the region between the workpiece and the die. The workpiece then takes the shape of the inner surface of the die.

However, this has the disadvantage that the system has a high thermal mass. That is, not only must the workpiece be heated to the temperature at which it becomes superplastic, but typically the whole processing chamber must also be heated to the same temperature. This obviously requires a large energy input in order to form the required piece.

U.S. Pat. No. 5,592,842 discloses a method which seeks to avoid the requirement for a mould. Specifically, this document proposes using a laser beam to locally heat parts of the workpiece, and then applying fluid pressure as in the conventional method.

However, this method has the disadvantage that this cannot accurately control the shape of the final product.

Moreover, the disclosed method makes no provision for annealing the workpiece, without which subsequent forming would not be satisfactory, or for heating the workpiece after forming, thereby eliminating residual stresses that may be produced by the forming process.

According to a first aspect of the present invention, there is provided a method of forming a workpiece, comprising:

holding the workpiece adjacent a mould;

using a laser to heat at least a part of the workpiece to a temperature sufficient to induce superplasticity; and

applying a fluid pressure to the workpiece, so that it takes the shape of the mould.

This has the advantage that the superplastic properties of the material can be used to form the workpiece precisely to the required shape, without needing to heat all of the processing chamber to the superplastic temperature.

Preferably, before using the laser to heat the workpiece to its superplastic temperature, the workpiece is clamped, and the laser is used to heat the whole of the workpiece to a substantially uniform temperature to anneal it.

Also preferably, after using the laser to superplastically form the workpiece, the laser is used to heat the whole of the workpiece to a substantially uniform temperature to remove any residual stresses.

This has the advantage that the whole of the forming can be carried out as a single process, in a single processing apparatus.

According to a second aspect of the present invention, there is provided a forming apparatus with a laser light source, and with means for holding a workpiece adjacent a mould.

For a better understanding of the present invention, and to show how it may be put into effect, reference will now be made, by way of example, to the accompanying drawings, in which:

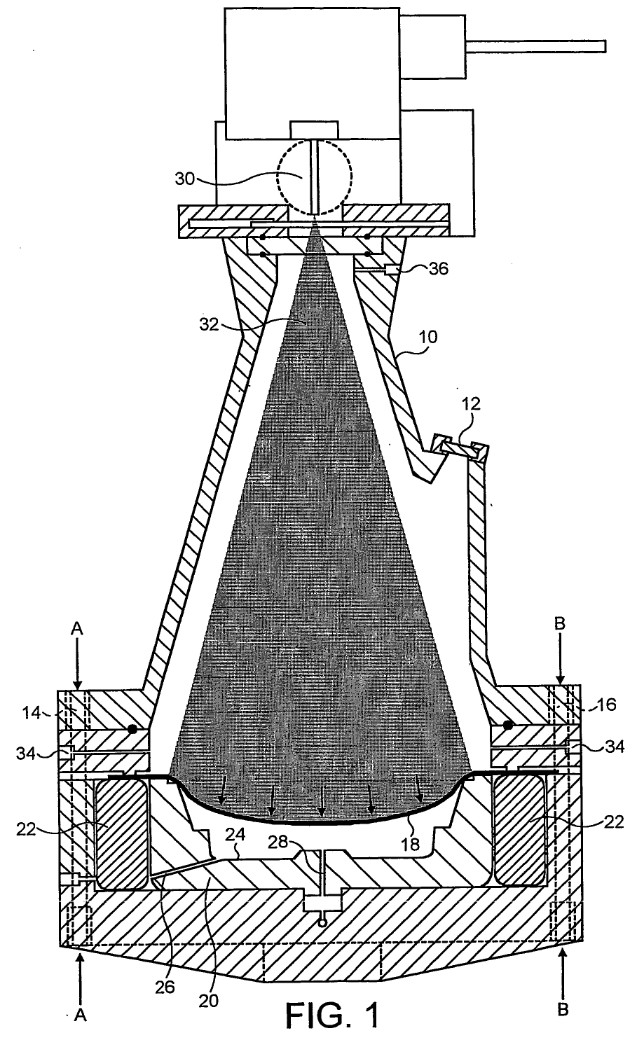

FIG. 1 is a schematic cross-sectional view through a forming apparatus in accordance with an aspect of the invention.

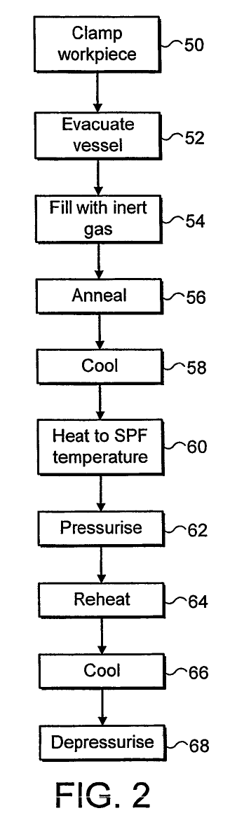

FIG. 2 is a flowchart illustrating a process in accordance with an aspect of the invention.

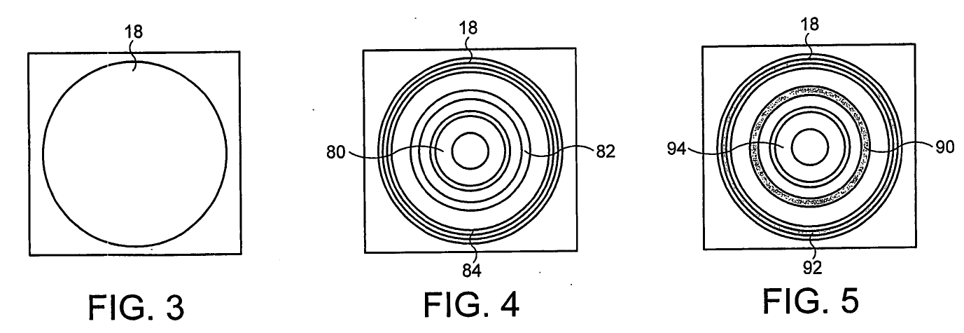

FIGS. 3-5 show the patterns of heating applied to a typical workpiece in accordance with the invention.

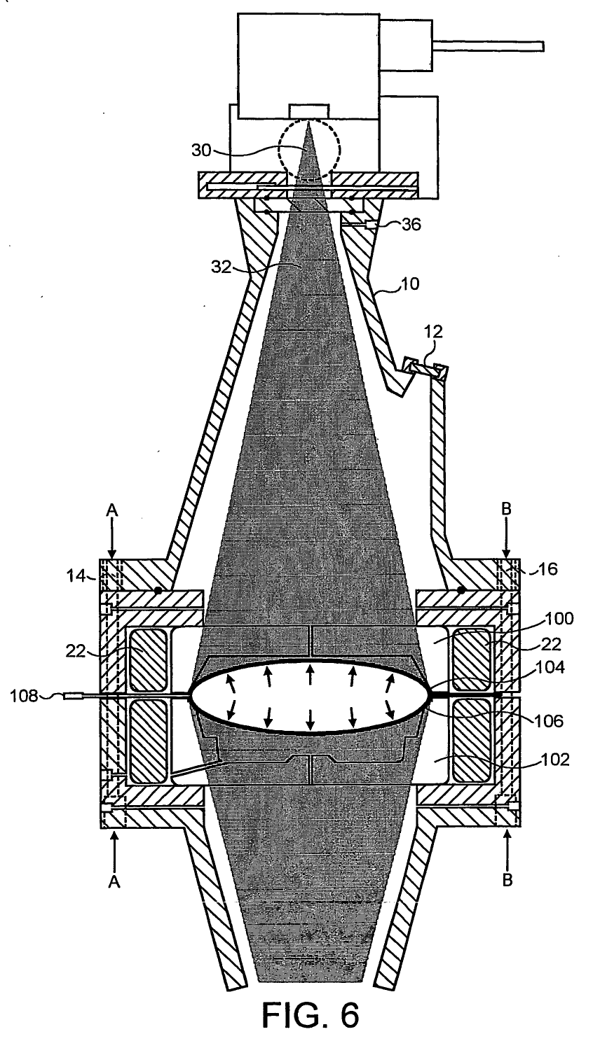

FIG. 6 is a schematic cross-sectional view through an alternative apparatus in accordance with the invention.

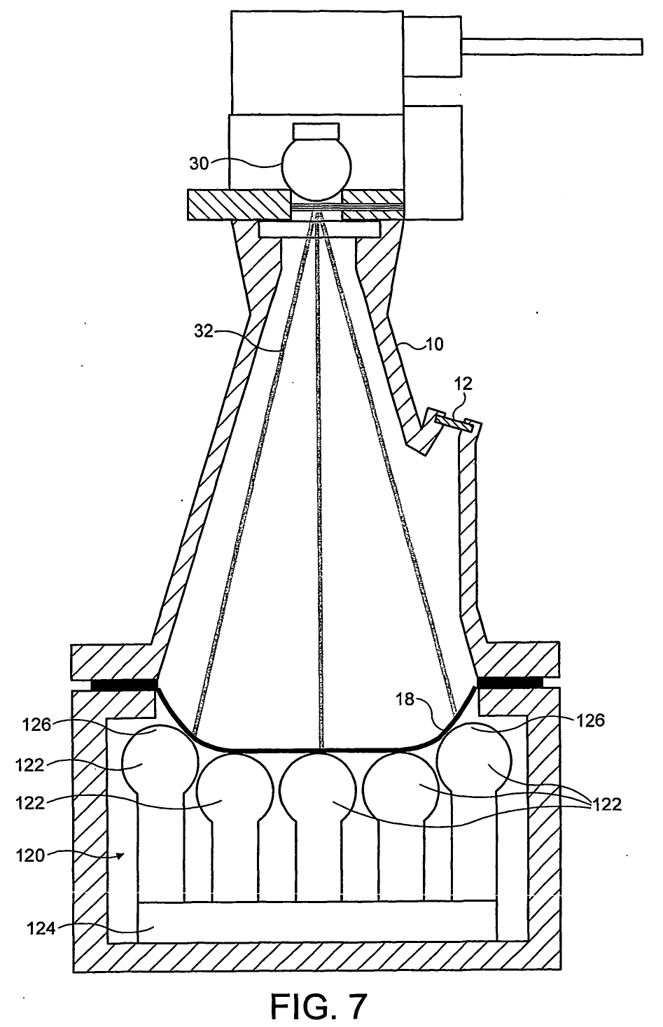

FIG. 7 is a schematic cross-sectional view through a further alternative apparatus in accordance with the invention.

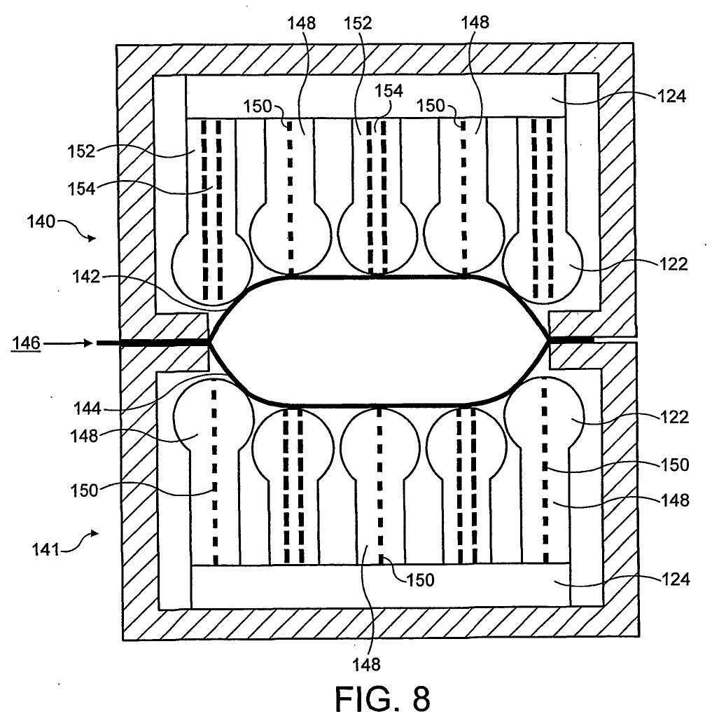

FIG. 8 is a schematic representation of a further alternative apparatus in accordance with the invention.

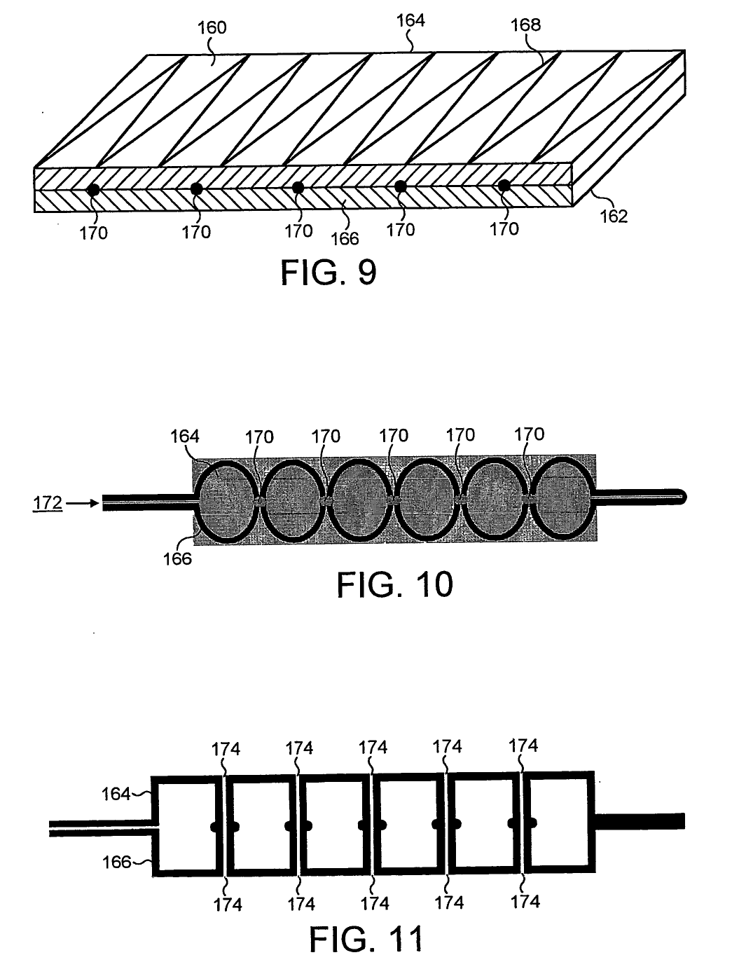

FIGS. 9-11 show stages in the process in accordance with an aspect of the invention.

FIG. 1 is a schematic cross-sectional view through the forming apparatus according to an aspect of the present invention. The apparatus includes a pressure vessel 10, having a viewing inlet 12. The vessel 10 includes a clamping system 14, 16, which can apply a clamping force as shown by arrows A-A, B-B, to hold a workpiece 18 in place.

The workpiece 18 is a sheet of the required superplastic alloy. As is well known to the person skilled in the art, the superplastic alloy may for example be a titanium-based alloy.

The workpiece 18 is preferably provided originally flat. FIG. 1 shows the workpiece having been partially deformed.

The apparatus includes a mould 20, located inside an insulating ring 22 made of a ceramic material. The upper surface 24 of the mould 20 conforms to the desired shape of the component after forming, and the mould 20 further includes bleed passages 26, 28.

The mould 20 may be made from either metallic or ceramic materials.

The apparatus also includes a laser light source 30, including means for controlling the focussing and direction of the laser beam 32.

The pressure vessel 10 also includes inlets 34 for gas, as well as an outlet 36.

FIG. 2 is a flowchart showing a forming process, in accordance with a preferred aspect of the invention, using the apparatus shown in FIG. 1.

Firstly, the workpiece, preferably in the form of a generally flat sheet of a superplastic material, is clamped in the clamping system 14, 16, in step 50 of the process. Then, in step 52, the vessel is evacuated by a vacuum pump, for example through the outlets 26, 28, 34, 36. Then, in step 54, the vessel is refilled with an inert gas, such as argon, at low pressure. This inert environment allows the component to be heated, without becoming contaminated with atmospheric gases.

Next, in step 56, the laser light source 30 is used to heat the whole of the workpiece 18, to a sufficiently high temperature that it is fully annealed and stress free. As shown in FIG. 3, the whole of the workpiece 18 is heated substantially uniformly. This is achieved by suitable control of the laser light source 30. For example, the laser light beam can be defocussed, so that it reaches all parts of the workpiece 18, or a focussed light beam can be scanned over all regions of the surface.

After annealing, in step 58, the workpiece is allowed to cool to below the superplastic temperature or, if possible, to below the grain-growth temperature.

Then, in step 60 of the process, the laser light source 30 is used to heat the workpiece 18 to its superplastic forming (SPF) temperature, for example at 935° C. In this case, as shown in FIG. 4, different regions of the workpiece 18 may be supplied with different amounts of energy from the laser light source 30. Thus, for illustrative purposes only, bands 80. 82, 84 are shown in FIG. 4, and they may receive different energy levels. Controlling the amount of energy supplied in this way allows superplasticity to be induced preferentially in some parts of the workpiece, rather than in others.

Next, in step 62 of the process, the vessel is pressurised. That is, inert gas, such as argon, is introduced through the gas inlets 34, in order to increase the pressure on the upper surface of the workpiece 18. At the same time, gas is allowed to escape from the underside of the workpiece 18 through the gas outlet channels 26, 28. In this preferred embodiment, the gas pressure on the upper side of the workpiece 18, within the vessel 10, may be increased to about 30 or 40 atmospheres (3 MPa or 4 MPa).

This pressure forces the hot workpiece into the mould 20, thereby forming a component having the same profile as the inner surface 24 of the mould.

Once the component has been formed, the laser source 30 can be used to reheat the formed component (step 64 in FIG. 2). As shown in FIG. 5, the distribution profile of the heat energy from the laser source may need to vary, for example between bands 92, 94, for example because of the now non-planar shape of the workpiece 18. Heating the component in this way eliminates any residual stresses within the component, that may have been induced as a result of the forming process, in order to produce components of superior accuracy and reproducibility without spring-back. The component can then be allowed to cool (step 66 in FIG. 2), and finally, in step 68 of the process shown in FIG. 2, the vessel can be depressurised.

FIG. 6 shows an alternative forming apparatus in accordance with an aspect of the present invention. The forming apparatus of FIG. 6 is adapted for use in forming components made of two sheets of material.

The apparatus of FIG. 6 is somewhat similar to that shown in FIG. 1, and corresponding components are indicated by the same reference numerals, and will not be described further.

In the case of the apparatus of FIG. 6, the apparatus includes a second laser light source (not shown) which is at an opposite end of the apparatus. The pressure vessel includes means for retaining two mould halves 100, 102, and for clamping two workpiece sheets 104, 106, whose edges may have been fused together, with an inlet 108, for introducing high pressure gas in between the two workpiece sheets 104, 106.

In this case, the laser light sources can be used to heat the mould halves 100, 102, and thereby raise the temperature of the workpiece sheets 104, 106 to their SPF temperature. Alternatively, and advantageously, the mould halves 100, 102 can be made from a material which is transparent to laser light, thereby allowing the laser light source to penetrate the mould halves, and heat the workpiece sheets directly. Suitable mould materials for this purpose can be either amorphous or crystalline ceramic, for example by ensuring that the grain size of the ceramic is smaller than the wavelength of the laser.

The mould halves 100, 102 may be designed for repeated use, or may be made in the form of a disposable liner.

The forming process, in the case of the apparatus shown in FIG. 6, is generally similar to that described with reference to FIG. 2, although in this case the high pressure gas is introduced between the two workpiece sheets 104, 106, in order to force the sheets into the respective mould halves 100, 102. In that case, the required high pressure is contained within the workpiece, and is of considerably smaller volume than in the situation shown in FIG. 1.

FIG. 7 is a schematic illustration of a further forming apparatus in accordance with an aspect of the invention. The apparatus of FIG. 7 is generally similar to that of FIG. 1, and the same reference numerals, when used in the two Figures, indicate corresponding features, and these features will not be described further.

In the apparatus of FIG. 7, the mould 120 is formed from an array comprising a large number of individually movable pillars 122, under the control of a servo system 124. Although only a few pillars 122 are shown in FIG. 7, an operational apparatus may include hundreds or thousands of such pillars.

Each pillar has a tip 126 which is made of, or coated with, a ceramic material.

The servo system 124 can control the height of each of the pillars 122, and can preferably also control the lateral positions of the pillars to a small extent. In this way, the array of pillars 122 can be used to form a mould of any desired shape. After use, the positions of the pillars can be adjusted to form a mould of a different desired shape. This allows many different components to be formed without requiring a corresponding number of different moulds.

The forming process is the same as that described earlier, in that the workpiece is clamped over the mould, then heated to its SPF temperature, and then a pressure is applied so that the workpiece takes the shape of the mould.

It will be appreciated that a mould of this type can also be used in an apparatus for forming components made from two sheets, as shown in FIG. 6.

It should further be noted that a mould of this type can be used in many different forming processes, not only those involving laser heating of workpieces, or superplasticity.

Thus, according to one aspect of the invention, there is provided an adjustable mould, comprising a plurality of individually adjustable pillars, and means for controlling the heights of the pillars, such that together the distal ends of the pillars form a mould surface.

FIG. 8 shows a further adaptation of a mould of this type, in this case in an apparatus for forming components made from two sheets. The mould of FIG. 8 is generally similar to that of FIG. 7, and the same reference numerals, when used in the two Figures, indicate corresponding features, and these features will not be described further.

In this case, the apparatus includes two moulds 140, 141 which are generally similar to the mould 120 of FIG. 7, together with an arrangement for clamping two workpiece sheets 142, 144, and an inlet 146 for introducing high pressure fluid in between them.

In the apparatus of FIG. 8, a first group of the pillars 148 each house respective optical fibres 150, which can direct radiation from the laser source (not shown), onto the adjacent area of the respective workpiece. Further, a second group of pillars 152 each house respective channels 154, which can direct cooling gas flows onto the adjacent area of the respective workpiece. The pillars 148, 152 of the first and second groups are generally alternated over the respective mould surfaces.

Thus, the apparatus of FIG. 8 allows precise control of the surface temperature of the workpiece, allowing superplasticity to be induced only in parts of the surface, if required.

As is known in the art, superplastic forming, using two workpiece sheets, can be used to form components with an internal, diffusion bonded, webbed support structure.

FIGS. 9-11 show such a process in accordance with the present invention. Thus, as shown in FIG. 9, the laser light source is used to pretreat the outer surfaces 160, 162 of the two workpiece sheets 164, 166 respectively. Where the laser light source is able to form a controllable beam, it can be used to scan across the surfaces 160, 162, as shown for example by the path 168 in FIG. 9. This removes any oxide which is present on the surfaces 160, 162, and the vaporised oxide can be vented out of the pressure vessel.

As is known, the two workpiece sheets 164, 166 are diffusion bonded together along lines 170. Then, when the two workpiece sheets 164, 166 have been heated to their SPF temperature, and high pressure fluid is introduced through inlet 172 between them, the two workpiece sheets are forced apart, as shown in FIG. 10.

Eventually, as shown in FIG. 11, regions of the outer surfaces 160, 162 come into contact, and the surface pretreatment allows the formation of high quality secondary diffusion bonds 174.

The use of the laser in the pretreatment means that this can be carried out as a part of the forming process, using the same forming apparatus.

There are therefore disclosed manufacturing methods which allow efficient use of superplastic forming.

1. A method of forming a workpiece, comprising:
holding the workpiece adjacent a mould;
using a laser to heat at least a part of the workpiece to a temperature sufficient to induce superplasticity therein;
applying a fluid pressure to the workpiece so that it takes the shape of the mould.

2. A method as claimed in claim 1, wherein the step of holding the workpiece comprises:
clamping the workpiece adjacent the mould;
using the laser to heat the whole of the workpiece to a substantially uniform temperature to anneal it; and
reducing the temperature of the workpiece to below the superplastic temperature thereof.

3. A method as claimed in claim 1, further comprising, after shaping the workpiece:
using the laser to heat the whole of the workpiece to a substantially uniform temperature to remove residual stresses therein.

4. A method as claimed in claim 1, wherein the mould comprises first and second halves, and the workpiece comprises first and second sheets, the method comprising:
holding the first and second sheets of the workpiece adjacent the first and second halves of the mould, respectively;
using the laser to heat at least parts of the first and second sheets of the workpiece; and
applying fluid pressure to the first and second sheets of the workpiece so that they take the respective shapes of the first and second halves of the mould.

5. A method as claimed in claim 4, wherein the step of applying fluid pressure comprises applying an increased fluid pressure between the first and second sheets of the workpiece.

6. A method as claimed in claim 4, wherein at least one of the first and second halves of the mould is transparent to the laser, and the step of using the laser to heat at least parts of the first and second sheets of the workpiece comprises heating at least one of the first and second sheets of the workpiece through said transparent half of the mould.

7. A method as claimed in claim 1, wherein the mould comprises a plurality of pillars, which are individually movable, such that distal ends of the pillars form a mould surface.

8. A method as claimed in claim 7, wherein at least some of the plurality of pillars include means for directing a laser beam at a workpiece held adjacent thereto.

9. A method as claimed in claim 7, wherein at least some of the plurality of pillars include means for directing a coolant at a workpiece held adjacent thereto.

10. A forming apparatus, comprising:
means for retaining a mould;
means for clamping a workpiece adjacent the mould;
a laser source, suitable for heating at least a part of a workpiece held in the clamping means; and
means for applying a fluid pressure to the workpiece so that it takes the shape of the mould.

11. A forming apparatus as claimed in claim 10, wherein the means for applying a fluid pressure to the workpiece comprises means for introducing a fluid on the side of the workpiece away from the mould.

12. A forming apparatus as claimed in claim 10, wherein the means for applying a fluid pressure to the workpiece comprises means for evacuating a region between the workpiece and the mould.

13. A forming apparatus as claimed in claim 10, wherein the means for retaining the mould comprises means for retaining first and second mould halves, and the means for clamping the workpiece comprises means for clamping first and second workpiece sheets adjacent the first and second mould halves, respectively.

14. A forming apparatus as claimed in claim 13, wherein the means for applying fluid pressure comprises means for applying an increased fluid pressure between the first and second workpiece sheets.

15. A forming apparatus as claimed in claim 13, comprising a mould wherein at least one of the first and second halves of the mould is transparent to the laser.

16. A forming apparatus as claimed in claim 10, wherein the mould comprises a plurality of pillars, which are individually movable, such that distal ends of the pillars form a mould surface.

17. A forming apparatus as claimed in claim 16, wherein at least some of the plurality of pillars include means for directing a laser beam at a workpiece held adjacent thereto.

18. A forming apparatus as claimed in claim 16, wherein at least some of the plurality of pillars include means for directing a coolant at a workpiece held adjacent thereto.

19. A product manufactured using a method in accordance with claim 1.
